(19) United States
(12) Patent Application Publication
(10) Pub. No.: US 2025/0123354 A1
(43) Pub. Date: Apr. 17, 2025

(54) METHOD AND SYSTEM FOR INTERFERENCE MITIGATION OF SIGNALS

(71) Applicant: AYAN SHARMA, Plano, TX (US)

(72) Inventor: AYAN SHARMA, Plano, TX (US)

(21) Appl. No.: 18/378,675

(22) Filed: Oct. 11, 2023

(51) Int. Cl. G01S 7/02; H04W 16/14

(52) U.S. Cl. CPC G01S 7/023; H04W 16/14

(57) ABSTRACT

The present invention discloses a method and system of mitigating interference between radar signals and wireless communication signal. The system comprises a wireless communication networks, a distributed radar sensor, a receiver chain, a processing unit, and an interference mitigation unit. The distributed radar sensors are configured to detect radar signals transmitted from a radar communication network. The processing unit is configured to extract a first parameter related to one or more radar signals, predicting a potential radar waveform of radar signals based on the first parameter, perform waveform matching between the potential radar waveform and the wireless communication signal, and determine a probability of interference between the radar signals and the wireless communication signals. The interference mitigation unit is configured to perform interference mitigation between the radar signals and the wireless communication signals.

### FIELD OF DISCLOSURE

The present invention relates to a coexistence mode between one or more radar signals and one or more wireless communication signals, and more particularly, relates to a method and a system of mitigating interference between the one or more radar signals and the one or more wireless communication signals.

### BACKGROUND OF DISCLOSURE

A wireless communication network uses CBRS-GAA (Citizens Broadband Radio Service spectrum-general authorized access) spectrum to serve the normal subscriber. A federal radar system is also in close proximity which could cause interference among both RF signals (radar RF signals and wireless communication RF signals). An interference zone causes data to be lost and this could happen at the radar terminal which is extremely crucial. Federal Communication Commission (FCC) has defined the radar signal as an incumbent user and when the radar signal turns on, they are detected by electronic stability control (ESC) sensors which further notify the spectrum access server (SAS). SAS has the responsibility to get the spectrum and channel number vacated within 5 minutes. This impacts the wireless communication signal because the user faces no service zone.

The spectrum sharing (SS) in CBRS (Citizens Broadband Radio Service spectrum) is not in co-existence mode. This means that radar signal cannot transmit at the same time when a commercial wireless communication signal is in operation. If that ever happens, then the wireless communication network must shut off the transmission within 300 seconds. This means that wireless communication signal technology must find a way to switch the active sessions (i.e. mobile devices) to nearby wireless communication signal cell sites or drop all the active sessions abruptly. This will continue till SAS indicates that radar is no longer active in a given geography. Such type of spectrum share is non-coexistence mode which means that both radar signal and wireless communication signal technology do co-exist and share the CBRS-GAA (Citizens Broadband Radio Service spectrum-general authorized access) but they cannot transmit simultaneously.

In order to support the better mechanism for CBRS, and to improve the SAS/ESC performance, there is a need for a “near real-time” novel design for the spectrum sharing technique. A design where both transmitters (wireless communication signal transmission as well as radar transmission) can co-exist and can radiate simultaneously with some intelligence built into the wireless communication signal system.

Accordingly, there exists a need for a design focused on near real-time spectrum sharing among 3GPP (third generation partnership project) based wireless communication signal technology and non-3GPP based radar technology.

### SUMMARY OF THE DISCLOSURE

In view of the foregoing disadvantages inherent in the prior art, the general purpose of the present disclosure is to provide a coexistence method, to include all advantages of the prior art, and to overcome the drawbacks inherent in the prior art.

An object of the present invention is to provide a coexistence mode where one or more radar signals and one or more wireless communication signals transmit simultaneously.

Another object of the present invention is to provide a design focused on near real-time spectrum sharing among 3GPP (third generation partnership project) based wireless communication signal technology and non-3GPP based radar technology.

Another object of the present invention is to provide a dynamic and extremely fast spectrum sharing.

In view of the above objects, in one aspect of the present invention, a system and a method of mitigating interference between multiple signals are provided. The method includes detecting, by a plurality of distributed radar sensors, one or more radar signals transmitted from a radar-based communication network; extracting, by a processing unit, at least one first parameter related to the one or more radar signals; predicting, by a processing unit, at least one potential radar waveform of the one or more radar signals based on at the least one first parameter; receiving, by a receiver chain, one or more wireless communication signals from a wireless communication network; extracting, by the receiver chain, at least one second parameter related to the one or more wireless communication signals; performing, by an interference mitigation unit, waveform matching; OFDMA like; between the at least one potential radar waveform and the one or more wireless communication signals; determining, by the interference mitigation unit, a probability of interference between the one or more radar signals and the one or more wireless communication signals based on the waveform matching; performing, by the interference mitigation unit, interference mitigation between the one or more radar signals and the one or more wireless communication signals based on the probability of interference by varying/modulating the at least one first parameter.

In one form, the method further includes continuously monitoring the one or more radar signals and the one or more wireless communication signals; determining a probability of interference between the one or more radar signals and the one or more wireless communication signals; and performing interference mitigation between the one or more radar signals and the one or more wireless communication signals, based on the probability of interference by varying/modulating the at least one first parameter.

In another embodiment, the at least one first parameters may include signal power, pulse rate, and signal information of the one or more radar signals.

In yet another embodiment, the at least one second parameters may include signal power, pulse rate, and signal information of the one or more wireless communication signals.

In yet another embodiment, the method further comprises executing a machine learning algorithm through the processing unit to convert the one or more radar signals to at least one potential radar waveform wireless communication signal-based OFDMA-like to perform waveform matching.

In one example embodiment, the interference mitigation unit may include nRT-RIC and NRT-RIC and the nRT-RIC notify NRT-RIC to trigger the interference handling process.

In one example embodiment, the interference handling process may include a bandwidth part switch, trigger blank subframe, beam alignment, and frequency evacuation.

In one example embodiment, the one or more radar sensors are configured, managed, and provisioned by the processing unit.

In one example embodiment, the one or more wireless communication signal is a 5G signal.

In yet another aspect of the present disclosure, is a system for mitigating interference between multiple signals. The system comprises a wireless communication network, a plurality of distributed radar sensors, a receiver chain, a processing unit, and an interference mitigation unit. The plurality of distributed radar sensors is configured to detect one or more radar signals transmitted from a radar based communication network. The receiver chain is coupled to the wireless communication network and is configured to receive the one or more wireless communication signals from the wireless communication network. The processing unit is coupled to the plurality of distributed radar sensors and is configured to extract at least one first parameter related to the one or more radar signals, predicting at least one potential radar waveform of the one or more radar signals based on the at least one first parameter. The receiver chain is configured to extract at least one-second parameter related to the one or more wireless communication signals. An interference mitigation unit is communicably coupled to the processing unit and the wireless communication network. The interference mitigation unit is configured to perform waveform matching between the at least one potential radar waveform and the one or more wireless communication signals, and determine a probability of interference between the one or more radar signals and the one or more wireless communication signals and is configured to perform interference mitigation between the one or more radar signals and the one or more wireless communication signals based on the probability of interference by varying/modulating the at least one first parameter.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawing, in which:

FIG. 1 illustrates a block diagram of the system, in accordance with an exemplary embodiment of the present disclosure;

FIG. 2 illustrates an event of interference when the one or more radar signals and the one or more wireless communication signals is getting interference during upload and download, in accordance with an exemplary embodiment of the present disclosure;

FIG. 3A illustrates a desired frame structure of wireless communication network, in accordance with an exemplary embodiment of the present disclosure;

FIG. 3B illustrates a radar signal time division duplexing (TDD) slot pattern during an event of interference when the one or more radar signals is getting interference from the one or more wireless communication signal, in accordance with an exemplary embodiment of the present disclosures;

FIG. 3C illustrates radar slots during an event of interference when the one or more radar signals is getting interference from the one or more wireless communication signal, in accordance with an exemplary embodiment of the present disclosures;

FIGS. 4A and 4B illustrate a flow chart, in accordance with an exemplary embodiment of the present disclosure;

FIG. 5 illustrates the wireless communication network (open radio access network (ORAN)) for spectrum share handling for the one or more radar signal in the CBRS GAA spectrum, in accordance with an exemplary embodiment of the present disclosure;

FIGS. 6A and 6B illustrate graphs plotted between frequency and time in an almost blank subframe technique, in accordance with an exemplary embodiment of the present disclosure;

FIG. 7 illustrates a graph plotted between the frequency and time in the bandwidth part switching mechanism, in accordance with an exemplary embodiment of the present disclosure; and

FIGS. 8A and 8B illustrate an antenna beam alignment technique during upload and download, in accordance with an exemplary embodiment of the present disclosure.

Like reference numerals refer to like parts throughout the description of several views of the drawing.

### DETAILED DESCRIPTION OF THE DISCLOSURE

The exemplary embodiments described herein detail for illustrative purposes are subject to many variations in implementation. The present disclosure provides a system and method of mitigating interference between multiple signals. It should be emphasized, however, that the present disclosure is not limited only to what is disclosed and extends to cover various alternations to the interference mitigation. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced items.

The terms “having”, “comprising”, “including”, and variations thereof signifies the presence of a component.

Further, various used in claims will be simplified to be used in description. For example, the plurality of distributed radar sensors may be hereinafter referred as ‘distributed radar sensors’, the one or more radar signals may be hereinafter referred as ‘radar signals’, the one or more wireless communication signals may be referred to as ‘wireless communication signals’, at least one first parameter may be referred to as ‘first parameter’, at least one second parameter may be referred to as ‘second parameter’, at least one potential radar waveform may be referred to as ‘potential radar waveform’.

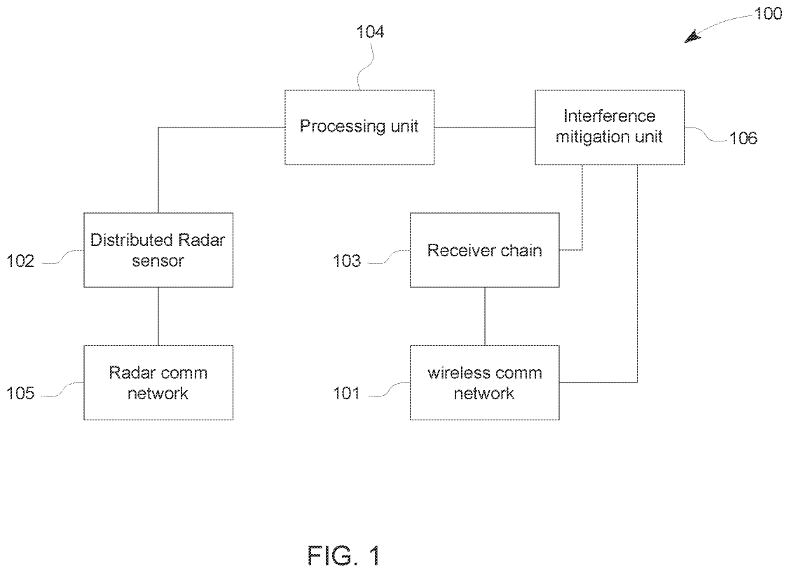

Referring to FIG. 1 illustrates the block diagram of the system of the present invention. The system is referred to as 100. The system 100 comprises a wireless communication network 101, a distributed radar sensor 102, a receiver chain 103, a processing unit 104, and an interference mitigation unit 106. The distributed radar sensors 102 are configured to detect radar signals transmitted from a radar communication network 105. The receiver chain 103 is coupled to the wireless communication network 101 and is configured to receive wireless communication signals from the wireless communication network 101. The processing unit 104 is coupled to the distributed radar sensors 102 and the interference mitigation unit 106 and is configured to extract a first parameter related to the radar signals, and predict a potential radar waveform of the radar signals based on the first parameter. A receiver chain 103 extracts a second parameter related to the wireless communication network and transfers the information to the interference mitigation unit. The interference mitigation unit is communicably coupled to the receiver chain 103 and the wireless communication network 101, which performs waveform matching between the potential radar waveform and the wireless communication signals, and determines a probability of interference between the radar signals and the wireless communication signals. The interference mitigation unit 106 is configured to perform interference mitigation between the radar signals and the wireless communication signals based on the probability of interference by varying/modulating the first parameter.

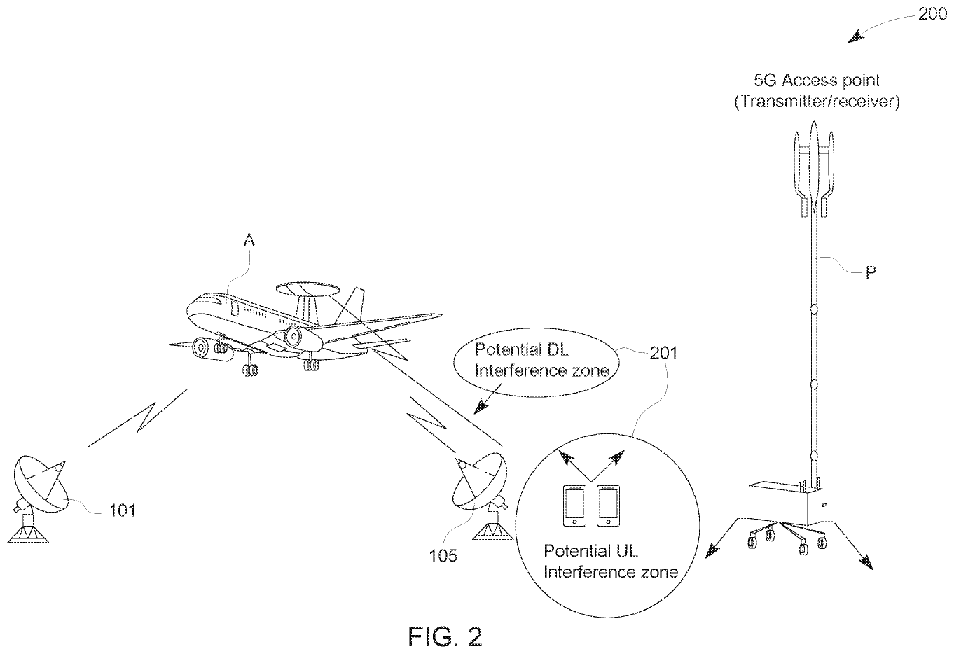

Referring now to FIGS. 2A and 2B describe an event of interference 200 between the radar signals and the wireless communication signals. As seen, the radar signals from a radar-based communication network 105 are transmitting the radar signals in the CBRS-GAA spectrum to airplane A. A nearby wireless communication network 101 from node P causes interference to the radar signals and receives a high level of noise and interference from the radar signals. There is a cross-link interference defined by the upload (UL) interference zone and the download (DL) interference zone 201, which means the uplink in radar communication network 105 is facing interference from the downlink of the wireless communication network 101 and vice versa.

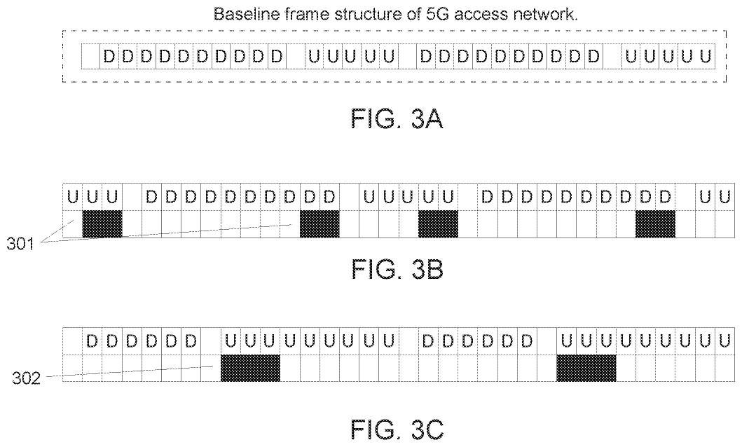

Referring to FIGS. 3A, 3B, and 3C which describe the desired frame structure of wireless communication network and radar signals TDD slot pattern with interfered slots as indicated by 301 and wireless communication TDD slot pattern with interfered slots indicated by 302. The interference source is mainly due to the reason that the wireless communication network 101 and the radar-based communication network 105 using different (time division duplexing) TDD slot patterns. Due to the fact that sensitive information like TDD slot configuration, frequency allocation to radar transmit terminals, when the radar signals are transmitting and for how long, and many more are never exchanged with the wireless communication network 101. It is up to the wireless communication network 101 (radio access network) RAN which needs to develop the analytics and intelligence to make some estimations and predictions for the radar signal behaviour based on the existing transmission of the radar signals and then take preventive measures to mitigate the interference to and from the radar signals.

The processing unit may hereinafter be referred to as ‘spectrum aware server’ and will be indicated by numeral 104 herein. The interference mitigation unit may be referred to as nRT-RIC and NRT-RIC herein.

The spectrum-aware server 104 works with multiple and non-collocated distributed radar sensors 102. The machine learning software within the spectrum-aware server is responsible for processing IQ samples from the distributed radar sensors 102. All geographically distributed radar sensors 102 are connected to the spectrum-aware server 104.

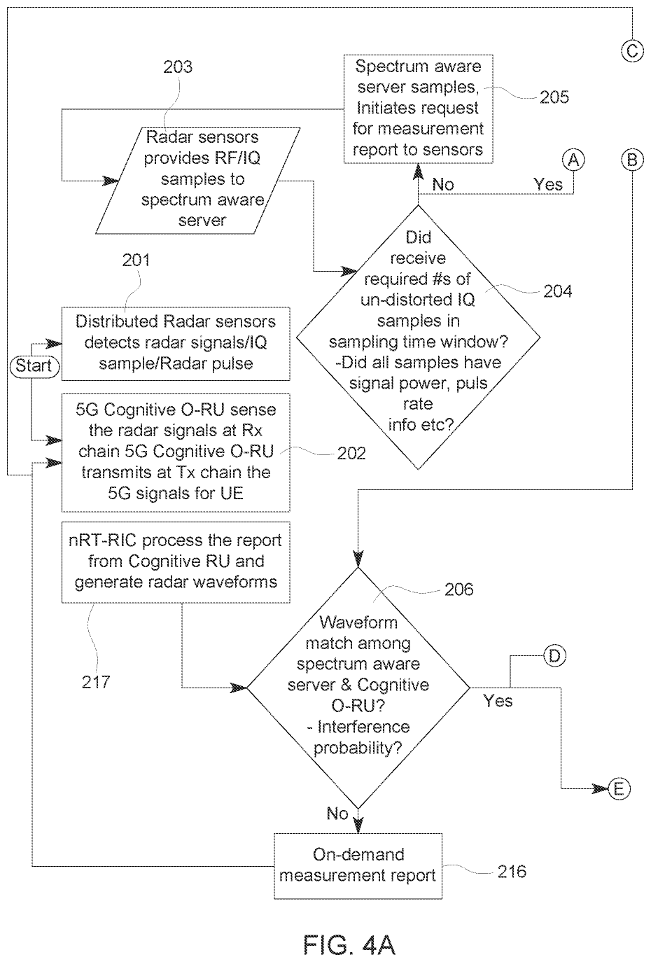

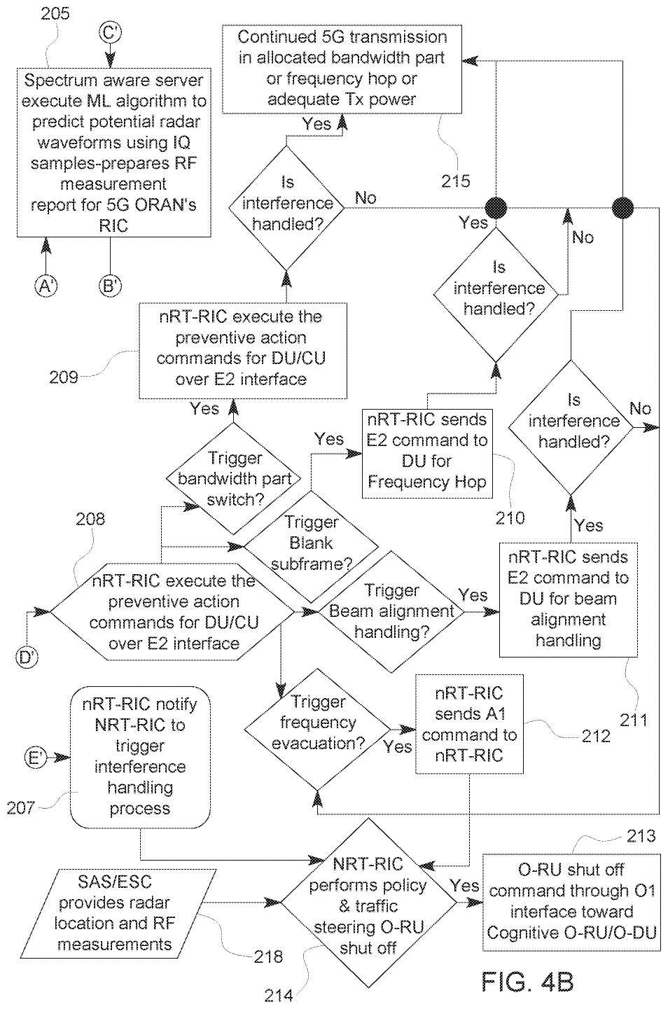

As seen in FIGS. 4A and 4B, a flowchart is described. The flow of the process starts at step 201 where the plurality of distributed radar sensors 102 detect one or more radar signals transmitted from the radar-based communication network 105. At step 202, the wireless communication signals are received by a receiver chain 103. At step 203, the distributed radar sensors 102 provide radio frequency signals and IQ samples to the spectrum-aware server 104. At step 204, the spectrum aware server 104 monitors whether received IQ samples have the first parameter which includes signal power, pulse rate, and signal information of the radar signals. If the first parameters are not received then at step 218, the spectrum-aware server 104 discards IQ samples and initiates a request for a measurement report to the distributed radar sensors 102. If the first parameters are received then at step 205, the spectrum-aware server 104 executes a machine-learning algorithm to predict the potential radar waveform using IQ samples and performs an RF measurement report. At step 206, the nRT-RIC server matches the waveform between the potential radar waveform and the wireless communication signals. If the waveform matches, then at step 207, the nRT-RIC notifies NRT-RIC that is (nRT-RIC) is triggering the interference handling process. At step 208, the nRT-RIC executes the preventive action commands. The three scenarios are expected. Firstly, if interference is detected and signal-to-interference and noise ratio (SINR) is low to high-range, and the potential radar waveform is spread across only some of the predefined bandwidth part (BWP) allocated bandwidths being used by the radar signals for any time duration (in the time domain) then at step 209, nRT-RIC sends commands to control unit or distributed unit 106 for bandwidth part switch. Secondly, if interference is detected & and SINR is low to mid-range, the potential radar waveform is spread across all predefined BWP allocated bandwidths (like radar signals, transmission is in either full 80 MHz span or multiple 10 MHz or multiple 20 MHz (in frequency domain) are being used by radar signals for any time duration (in time domain), then at step 210, nRT-RIC sends commands to control unit or distributed unit 107 for an almost blank subframe. Thirdly, if interference is detected and SINR is low to high-range and the potential radar waveform is using a wide beam and spread across all of predefined BWP allocated bandwidths (like radar transmission could be in full 80 MHz span or using some 10 MHz or some 20 MHZ (in frequency domain) and neither ABS nor BWP switch could not help then at step 211, nRT-RIC sends commands to control unit or distributed unit 107 for beam handling. Fourthly, if interference is very high or the radar signals occupy a full 80 MHz span then at step 212, nRT-RIC sends commands to NRT-RIC. At step 213, it is checked whether the NRT-RIC performs policy and traffic steering shut-off. If NRT-RIC can perform, then at step 214, wireless communication network 101 shuts off the command through the O1 interface towards the cognitive control unit or distributed unit 107; which means wireless service is off the air. If the interference is handled by these techniques, then at step 215, the continued wireless transmission in the allocated bandwidth part or frequency hop or beam handling or in frequency evacuation. If the waveform matching is not there at step 205, then at step 216, a measurement report is demanded from the distributed radar sensors 102.

The process is defined in detail as follows: the distributed radar sensors 102 are installed in a given cluster in close proximity to wireless communication network 101. The distributed radar sensors 102 are capable of performing low latency detection of the radar signals, along with the radar's signal energy, and angle of arrival of the radar signals, and finally report back the raw data to the spectrum aware server 104. The distributed radar sensors 102 provide spatial diversity gain and increase the probability of detecting the radar signals more accurately. The distributed radar sensors 102 are configured to detect the radar signals. A machine learning algorithm is designed to process large samples from the distributed radar sensors 102 and predict the possible waveforms of the radar signals to identify the frequency channel number, bandwidth, center frequency, and RF energy the radar signal is using. Once the potential radar waveform is predicted within the wireless communication network 101 (ORAN) network components like cognitive radio unit (CR-ORU) 108 which sense and process the radar signals and provide the IQ samples to near real-time Ran intelligent controller (nRT-RIC). Then nRT-RIC is used to compare the waveforms sampling with the wireless communication signal-based OFDMA signal waveforms. The ORAN's RIC (RAN intelligent controller) in nRT-RIC decides if the interference from the radar signals is quantitively measured from the spectrum-aware server 104, and compares the reported interference from spectrum-aware server 104 against the wireless communication measurement report and threshold defined within RIC to take preventive actions against interference to the radar signals. These actions could be efficient handling or switching of wireless communication based “Bandwidth part” or blanks subframe in allocated frequency or completely vacating the frequency band. A policy-based decision is taken from non-real-time RIC (NRT-RIC) and the interference-based decision is taken at near-real-time RIC (nRT-RIC).

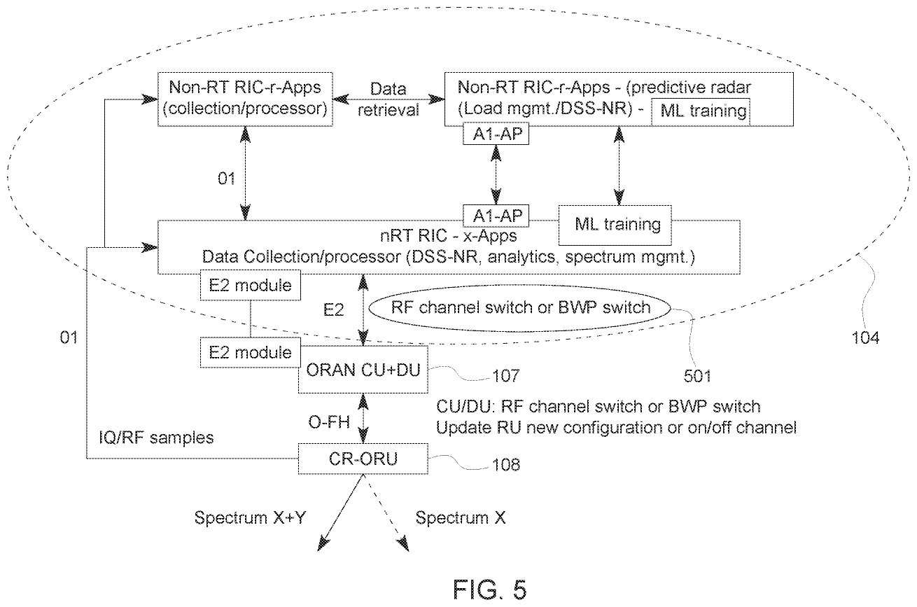

More specifically as seen in FIG. 5, the spectrum-aware server 104 acts like a main node for the shared license access node which has pre-configured information and input from SAS/ESC and gets updated periodically with the radar signal information like signal power, locations, etc. It collects the inputs from the distributed radar sensors 102 which sends the radar signals information and IQ samples when and where detected. The spectrum aware server 104 also has an ML model which helps to process the large IQ data and predict the potential radar waveform. Spectrum aware server 104 compares the calculations with SAS/ESC data if available against the data and calculations received and made from radar sensors 102. If no data is provided by SAS/ESC then it will provide the output (frequency channel number, frequency bandwidth, center frequency, and RF energy) to the nRT-RIC server for further processing what it received from radar sensors 102 only. If SAS/ESC has provided the relevant information of the existing radiating radar signals then the spectrum-aware server 104 will validate that information with the data provided by the distributed radar sensors 102 in terms of RF power spectral density and positioning. If SAS/ESC provides extra information on radiating the radar signals like latitude/longitude information, type of the one or more radar signals (static/nomadic), etc. which are not known to the distributed radar sensors 102 then spectrum aware server 104 will append the report prior to submission to nRT-RIC.

In one example embodiment, the NRT-RIC module executes the spectrum sharing policy decision like migrating the active user equipment (UEs) from one cell to another cell, identifying the (user equipment) UEs that could be dropped in the event of spectrum evacuation, handling SAS/ESC reporting/updates and modifications, Handling the Cognitive RU through O1 interface in case cell needs to be turned off. The NRT-RIC module also handles “rApps” which are used to provide the RAN enrichment information from non-3GPP nodes.

In one example embodiment, the nRT-RIC module executes the wireless communication radio access network's resource sharing model which is a time and frequency grid (i.e. Physical resource block-PRBs), executes ML algorithm once post-processing report from Cognitive O-RU sends the report having the radar signals, radar RF energy, and pulse repetition rate. The nRT-RIC module has the capability of translating O1 info from Non-RT RIC into wireless communication signal ORAN's reconfiguration control and data on DU-CU 107 management. It also has analytics capability so it can compare the 3GPP-based wireless measurement report from Cognitive ORU 108 and compare against the spectrum aware server 104 which it receives periodically or on demand basis. An nRT-RIC has a module for multiple “xApps”, which are microservices that can be used to perform radio resource management (like Bandwidth part allocation and switching, the almost blank subframe initiation and stop, fine-tuning of beam alignment and beam-null, and a few more) through standardized interfaces (E2-AP modules) and ML based service models.

In one form, the nRT-RIC's ML algorithm estimates the potential radar waveform from post-processing IQ samples from CR-ORU 108 and aggregates the assessment with Spectrum-aware server reports. It runs another module of the ML algorithm to compare the potential radar's waveform with the wireless communication signal-based OFDMA waveform to estimate the potential interference caused by the wireless communication signal from the radar signals. If both frequency channel collides at the wireless communication signal's PRB (time and frequency grid) then interference is assumed to be present.

In one form, the nRT-RIC executes another ML model to compare the RF energy among the potential radar waveform against the wireless communication signal's transmitted OFDMA waveform to predict the “Signal to Interference and Noise ratio (SINR)” to validate if instantaneous value of SINR has crossed the threshold & pre-define value of SINR. Here signal represents the wireless communication signal OFDMA. RF signal power spectral density interference represents the radar's signal power spectral density and noise is external noise if any and uplink noise from all sources. The threshold values are pre-configured in nRT-RIC and corresponding actions and ruling enforcement are prioritized within DU/CU 107 and nRT-RIC.

In one example embodiment, the control unit and distributed unit 107 executes resource sharing enforcement, collect and report RAN statistics to Non-RT-RIC via O1/E2 logical interfaces, enable spectrum share by using 3GPP based features sets like BWP (bandwidth part switching) for co-existence mode, enable Almost blank subframe (ABS) to transmit empty frame with low energy in those frequency channels which can cause same channel interference with radar channel or beam alignment and beam null so that 5GRF energy continues with narrow beam for certain UEs and still avoid interference to/from radar. All functionalities are executed by DU & and CU and assumed to be supported from a software perspective at CR-ORU.

In one example embodiment, a CR-ORU 108 is equipped with cognitive capabilities, which means wireless communication transmission as well as radar spectrum sensing. It is capable of being configured with Full cognitive parameters that a wireless communication network can be aware of and simultaneously spectrum-sensing CR detects channels in the same CBRS-GAA spectrum.

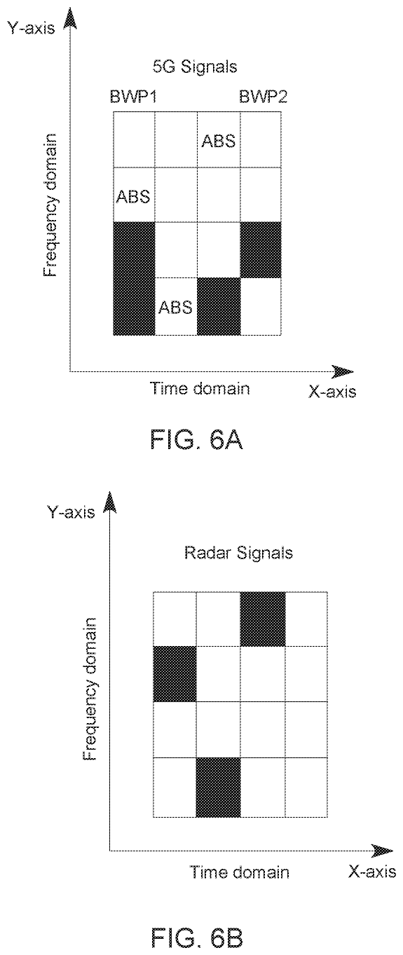

In one form, the following three scenarios are expected by enabling “xApps”. If interference is detected & and SINR is low to mid-range, the potential radar waveform is spread across all predefined BWP allocated bandwidths (like the radar signals, transmission is not in either full 80 MHz span or multiple 10 MHz or multiple 20 MHz (in frequency domain) are being used by the radar signals for any time duration (in time domain), the almost blank subframe technique is used to avoid interfering the wireless communication signal RF signals to the radar's signal transmission. A dedicated xApps module is designed within nRT-RIC as well as in the ODU platform server. Both modules coordinate and perform the execution of steps to enable, disable, and modify the almost blank subframe, start/stop boundary in near real-time. FIGS. 6A and 6B show the graph plotted across frequency with time domain in the almost blank subframe. The blank subframe is a method that is designed to reduce the interference created when the radar signals and the wireless communication signals are transmitting exactly the same frequency channel. In this technique, it is assumed that once the wireless communication signal's nRT-RIC estimates the potential radar's waveforms and compares against the OFDMA wireless communication signal waveforms and then identifies the opportunity in terms of time and frequency resources where the wireless communication signal continues the transmission with reduced quality of service (i.e. transmission of control and reference signals so UE does not think that there is a radio link failure) instead of complete shut off the cell site. The radar signal performance is not impacted at all by this method. The wireless communication signal's cognitive ORU 108 transmits the signal at very low power instead of completely stopping the transmission. This subframe with very low signal power is called ‘Almost Blank Subframe (ABS)’. 3GPP-defined ABS will carry only fundamental reference signals without any user data.

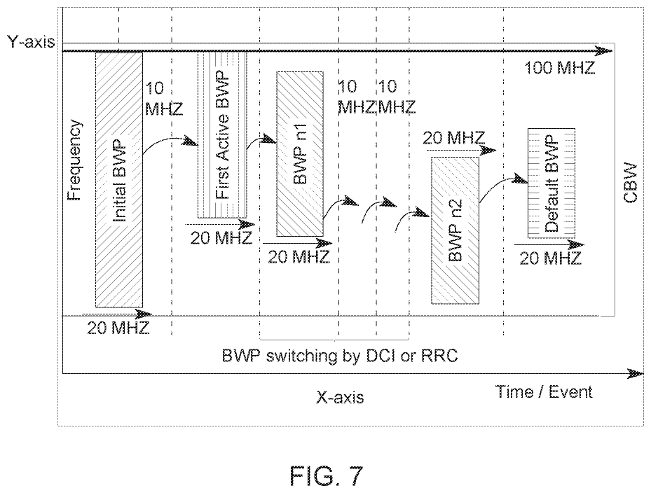

In yet another example, if interference is detected and SINR is low to high-range and the potential radar waveform is spread across only some of predefined BWP allocated bandwidths (like radar transmission is not in full 80 MHz span but using some 10 MHz or some 20 MHz (in frequency domain) are being used by the radar signals for any time duration (in the time domain) then BWP switch could be an approach. The wireless communication signals users can utilize the contiguous bandwidth in an all-time domain. A dedicated xApps for the BWP switch module is designed within nRT-RIC as well as in the ODU platform server. Both modules coordinate and perform the execution of steps that are responsible for enabling, disabling, and modifying the BWP start/stop boundary & and BWP switch in near real-time. FIG. 7 shows the graph plotted across frequency with time showing bandwidth part that can be operated through bandwidth part switch 501. The Bandwidth Part (BWP) is a contiguous set of physical resource blocks (PRBs) on a given frequency channel. Each BWP is defined with its own sets of symbol durations. It is assumed that a BWP of 80 MHz, 60 MHz, 40 MHz, 20 MHz, and 10 MHz are supported. A BWP is defined in a time and frequency grid. If the radar signal consumes only a 10 MHz band at any given time, then the wireless communication signal ORAN can use the remaining 60 MHz spectrum associated BWP. An extra 10 MHz is left to support the guard band.

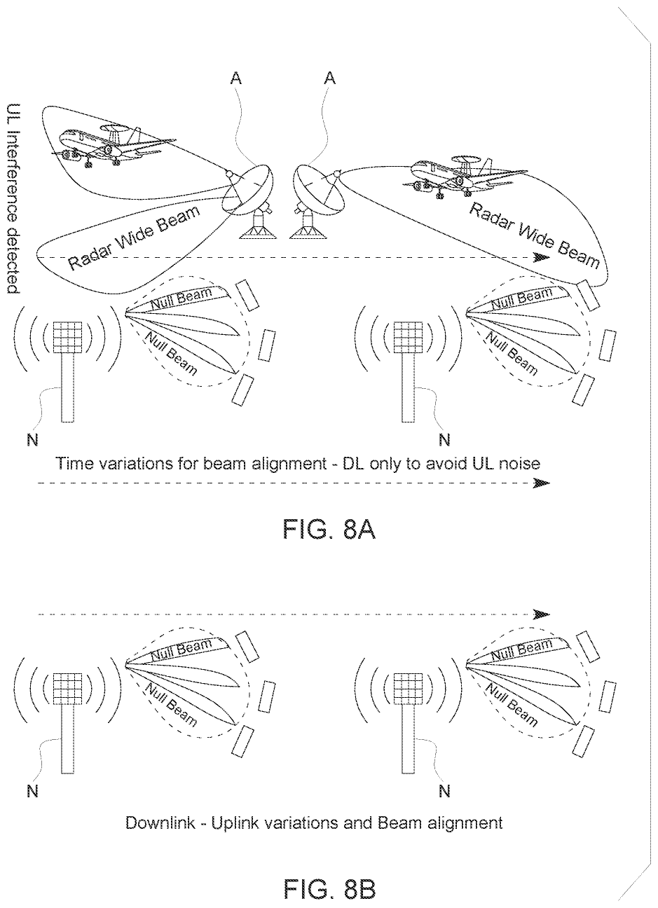

In yet another example, if interference is detected and SINR is low to high-range and the potential radar waveform is using a wide beam and spread across all of predefined BWP allocated bandwidths (like radar transmission could be in full 80 MHz span or using some 10 MHz or some 20 MHz (in frequency domain) and neither ABS nor BWP switch could help then beam alignment or beam-null is created in the direction where the radar signal is transmitting. A spatial distance is considered in this scenario like the position of the radar signal the position of the wireless communication signal CR-ORU 108 and the location of interference. If radar is using a narrow beam then the wireless communication signal DU-CU 107 and nRT-RIC can calculate which wireless communication signal narrow beam should be turned as null beam & remaining beam can still be active as shown below in FIGS. 8A and 8B. A dedicated xApps module is designed within nRT-RIC as well as in the ODU platform server. Both modules within nRT-RIC and wireless communication signal-ODU coordinates and perform the execution of steps which is responsible for enabling, disabling, and modifying the beam alignment procedure, producing beam null in direction with respect to radar signals, handling UL/DL transmission switch to mitigate by controlling the analog beam forming within CR-ORU module 108 in near real-time. It is a method to adjust the antenna beam in a certain direction to avoid the victim's RF signals. This concept is limited to specific wireless communication signal-supporting radio units A which have a large number of antenna array elements that are controlled by the wireless communication signal's ODU. A beam null is one of the specific scenarios in which only reference signal is transmitted from node N with 40 milliseconds (msec.) periodicity which could be configured to 80 msec, or even more in case interference is still detected. In the event of beam-null, it is expected that there will be no high-power RF energy transmitted by the one or more wireless communication signal radio unit A. Wireless communication signal-based beam alignment in the downlink is applied to reference signals (RSs) such as Synchronization Signal Blocks (SSBs) and Channel State Information Reference Signals (CSI-RSs) using different beams to search the whole angular space.

In one example embodiment, if interference is very high or radar occupies a full 80 MHz span then the wireless communication network vacates the full band on a single cell or all cells of the wireless communication signals base station. In case nRT-RIC identifies some scope of retaining the CBRS spectrum but still reporting interference to/from the radar signals then it will evacuate the CBRS full GAA spectrum and wait till the radar signal is finished with its transmission and reported by the SAS/ESC server.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A method of mitigating interference between multiple signals, the method comprising:
detecting, by a plurality of distributed radar sensors, one or more radar signals transmitted from a radar-based communication network;
extracting, by a processing unit, at least one first parameter related to the one or more radar signals;
predicting, by the processing unit, at least one potential radar waveform of one or more radar signals based on at the least one first parameter;
receiving, by a receiver chain, one or more wireless communication signals from a wireless communication network;
extracting, by the receiver chain, at least one second parameter related to the one or more wireless communication signals;
performing, by an interference mitigation unit, waveform matching, OFDMA like, between the at least one potential radar waveform and the one or more wireless communication signals;
determining, by the interference mitigation unit, a probability of interference between the one or more radar signals and the one or more wireless communication signals based on the waveform matching;
performing, by the interference mitigation unit, interference mitigation between the one or more radar signals and the one or more wireless communication signals based on the probability of interference by varying/modulating the at least one first parameter.

2. The method as claimed in claim 1, further comprising:
continuously monitoring the one or more radar signals and the one or more wireless communication signals;
determining a probability of interference between the one or more radar signals and the one or more wireless communication signals; and
performing interference mitigation between the one or more radar signals and the one or more wireless communication signals, based on the probability of interference by varying/modulating the at least one first parameter.

3. The method as claimed in claim 1, wherein the at least one first parameters are signal power, pulse rate, and signal information of the one or more radar signals.

4. The method as claimed in claim 1, wherein the at least one second parameters are signal power, pulse rate, and signal information of the one or more wireless communication signals.

5. The method as claimed in claim 1, further comprising executing machine learning algorithm through a spectrum aware server to convert the one or more radar signals to the at least one potential radar waveform, 5G based OFDMA like, to perform waveform matching.

6. The method as claimed in claim 1, wherein the interference mitigation unit includes nRT-RIC and NRT-RIC.

7. The method as claimed in claim 6, wherein the nRT-RIC notify NRT-RIC to trigger interference handling process.

8. The method as claimed in claim 7, wherein the varying/modulating the at least one first parameter is performed by the interference mitigation unit through interference handling process such as but not limited to bandwidth part switch, trigger blank subframe, beam alignment, and frequency evacuation.

9. The method as claimed in claim 1, wherein the plurality of distributed radar sensors is provisioned and managed by a spectrum aware server.

10. The method as claimed in claim 1, wherein the one or more wireless communication signal is 5G.

11. A system for mitigating interference between multiple signals, comprising:
a wireless communication network;
a plurality of distributed radar sensors configured to:
detect one or more radar signals transmitted from a radar based communication network;
a receiver chain communicably coupled to the wireless communication network, wherein the receiver chain is configured to receive a one or more wireless communication signals from the wireless communication network;
a processing unit communicably coupled to the plurality of distributed radar sensors, wherein the processing unit is configured to:
extract at least one first parameter related to the one or more radar signals, and
predict at least one potential radar waveform of the one or more radar signals based on the at least one first parameter,
the receiver chain is configured to extract at least one second parameter related to the wireless communication network,
an interference mitigation unit communicably coupled to the processing unit and the wireless communication network, wherein the interference mitigation unit is configured to:
perform waveform matching between the at least one potential radar waveform and the one or more wireless communication signals, and
determine a probability of interference between the one or more radar signals and the one or more wireless communication signals; and
perform interference mitigation between the one or more radar signals and the one or more wireless communication signals based on the probability of interference by varying/modulating the at least one first parameter.

12. The system as claimed in claim 11, the at least one first parameters are signal power, pulse rate, and signal information of the one or more radar signals.

13. The system as claimed in claim 11, wherein the at least one second parameters are signal power, pulse rate, and signal information of the one or more communication signals.

14. The system as claimed in claim 11, wherein machine learning algorithm is executed to convert the one or more radar signals to the at least one potential radar waveform to perform waveform matching.

15. The system as claimed in claim 11, wherein the interference mitigation unit mitigates the interference based on bandwidth part switch, trigger blank subframe, beam alignment, or frequency evacuation.

16. The system as claimed in claim 11, wherein the one or more wireless communication signal is 5G.
